(19) United States
(12) Patent Application Publication
(10) Pub. No.: US 2026/0152000 A1
(43) Pub. Date: Jun. 4, 2026

(54) LIQUID DISCHARGE HEAD AND METHOD FOR MANUFACTURING LIQUID DISCHARGE HEAD

(71) Applicant: CANON KABUSHIKI KAISHA, Tokyo (JP)

(72) Inventor: YU KATANO, Kanagawa (JP)

(21) Appl. No.: 19/396,093

(22) Filed: Nov. 20, 2025

(30) Foreign Application Priority Data
Dec. 3, 2024 (JP) 2024-210521

(51) Int. Cl. B41J 2/16; B41J 2/165

(52) U.S. Cl. CPC B41J 2/1623; B41J 2/162; B41J 2/16502

(57) ABSTRACT

A liquid discharge head includes a discharge chip including a discharge port for discharging liquid, and a cover member having an opening for exposing the discharge chip, the cover member including a first surface which is joined to the discharge chip with adhesive, and a second surface opposite from the first surface, wherein, at least in a part of the opening as viewed from a direction perpendicular to the second surface, an edge on the second surface side is positioned inside the opening with respect to an edge on the first surface side.

### BACKGROUND

### Field of the Technology

The present disclosure relates to a liquid discharge head, and a method for manufacturing the liquid discharge head.

### Description of the Related Art

During the manufacturing of liquid discharge heads, highly accurate alignment is required at the time of joining members, especially, joining a substrate including discharge ports and another member. In manufacturing liquid discharge heads, due to constraints, such as component geometry, a method is often used in which a detection portion is disposed on each component to perform alignment using image processing instead of an alignment method of providing alignment surfaces for members and bringing the alignment surfaces into contact with each other.

Examples of the method in which a detection portion is disposed on each component to perform alignment include a method using an alignment mark. Japanese Patent Laid-Open No. 2003-305851 describes a method of, during joining a liquid chamber partition member and a vibration plate, performing alignment by image processing using a charge-coupled device (CCD) camera using alignment marks that are each provided to the liquid chamber partition member and the vibration plate.

To manufacture liquid discharge heads, it may be difficult to provide an alignment mark depending on the member. For example, in a component exposed on the outermost surface of a liquid discharge head in a direction for discharging liquid from the discharge ports, such as a face cover, the outermost surface affects wiping performance using a blade at the time of cleaning and the like. Thus, an alignment mark may reduce the wiping performance due to the irregularities caused by the alignment mark.

### SUMMARY

In view of these circumstances, the present disclosure is directed to providing a liquid discharge head with members highly accurately aligned with each other and a method for manufacturing the liquid discharge head.

According to some embodiments of the present disclosure, a liquid discharge head includes a discharge chip including a discharge port for discharging liquid, and a cover member having an opening for exposing the discharge chip, the cover member including a first surface which is joined to the discharge chip with adhesive, and a second surface opposite from the first surface, wherein, at least in a part of the opening as viewed from a direction perpendicular to the second surface, an edge on the second surface side is positioned inside the opening with respect to an edge on the first surface side.

According to another aspect of the present disclosure, a method for manufacturing a liquid discharge head, the liquid discharge head including a discharge chip including a discharge port for discharging liquid, and a cover member having an opening for exposing the discharge chip, the cover member including a first surface which is joined to the discharge chip with adhesive, and a second surface which is a surface opposite from the first surface, wherein, at least in a part of the opening as viewed from a direction perpendicular to the second surface, an edge on the second surface side is positioned inside the opening with respect to an edge on the first surface side, the method includes applying the adhesive to the discharge chip, performing image processing including imaging the discharge chip and the edge on the second surface side in at least the part of the opening in the cover member using a camera disposed in the direction perpendicular to the second surface, adjusting a position of the cover member with respect to the discharge chip based on a result of the image processing, and joining the discharge chip and the cover member by curing the adhesive.

Features of the present disclosure will become apparent from the following description of embodiments with reference to the attached drawings. The following description of embodiments is described by way of example.

### BRIEF DESCRIPTION OF THE DRAWINGS

FIG. 1 is a perspective view of an example of a liquid discharge apparatus.

FIG. 2 is a perspective view of an example of a liquid discharge head.

FIG. 3 is a perspective view of an example of a liquid discharge unit.

FIG. 4 is an exploded perspective view of an example of the liquid discharge unit.

FIGS. 5A and 5B are cross-sectional views of an example of a discharge chip.

FIGS. 6A to 6D are each a plan view of the discharge chip and a cover member.

FIG. 7 illustrates a procedure of a process of joining the discharge chip and the cover member.

FIGS. 8A and 8B each illustrate positions of a camera in an image processing process S2.

FIG. 9 is an enlarged view illustrating a positional relationship between the discharge chip and the cover member that are joined.

FIGS. 10A and 10B illustrate cross-sections of the cover member and positions of the camera according to an embodiment and a comparative example, respectively.

FIGS. 11A and 11B are illustrative views of images captured in the image processing process according to the embodiment and the comparative example, respectively.

FIG. 12 illustrates a part of a process of forming the cover member using a punching method.

FIG. 13 illustrates a part of a process of forming the cover member by etching.

FIG. 14 is a cross-sectional view of the discharge chip and the cover member after adhesive is cured.

### DESCRIPTION OF THE EMBODIMENTS

Various exemplary embodiments, features, and aspects will be described for implementing the present disclosure with reference to the drawings. Like reference numerals refer to like components having similar functions, and redundant descriptions may be omitted. In the following description, an example will be described in which the present disclosure is applied to a liquid discharge head included in a liquid discharge apparatus serving as an inkjet printer. However, the present disclosure is not limited to the embodiment described below, and changes, such as other embodiments, additions, modifications, and omissions, can be made within the scope conceivable by those skilled in the art. In any forms, as long as the functions and the effects of the present disclosure can be achieved, such changes are considered to be within the scope of the present disclosure.

Components described below are merely examples, and are not intended to limit the scope of the present disclosure to those components alone. The present disclosure will be described using specific examples involving a liquid discharge recording head. However, the present disclosure is not limited to these examples, and various modifications and changes can be made within the scope of the gist thereof.

### 1. Configuration of Liquid Discharge Apparatus

### 1.1 Overview of Configuration of Liquid Discharge Apparatus

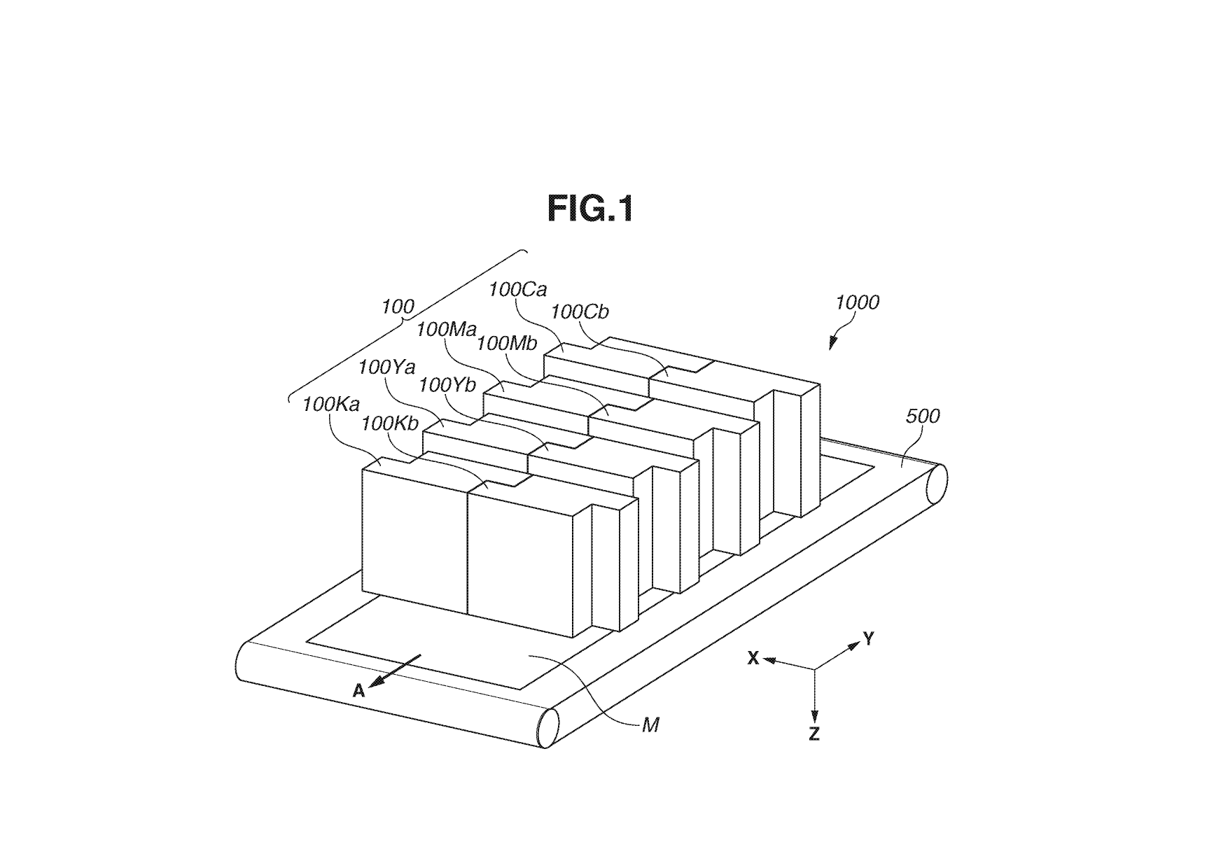

FIG. 1 is a schematic perspective view of a general configuration of a liquid discharge apparatus 1000 according to a first embodiment to which the present disclosure is applicable. The liquid discharge apparatus 1000 according to the present embodiment is of a one-pass type capable of forming an image or the like by discharging liquid to a medium M in a single movement of the medium M, and discharge ports for discharging the liquid are arranged so as to discharge liquid for the entire width of the medium M. Liquid discharge heads 100 according to the present disclosure are, for example, detachably attached to the liquid discharge apparatus 1000.

The medium M is conveyed in a direction indicated by an arrow A by a conveyance unit 500, and is subjected to recording by the liquid discharge heads 100. In each liquid discharge head 100, which will be described in the following, liquid discharge units 10 each including a discharge chip 1 capable of discharging the liquid are disposed on a support member 40.

The liquid discharge heads 100 are positioned in the liquid discharge apparatus 1000 using a reference member. FIG. 1 illustrates the liquid discharge apparatus 1000 including the liquid discharge heads 100 capable of discharging ink of four colors, i.e., black, yellow, magenta, and cyan, respectively. Two liquid discharge heads 100 for each color are provided, which means eight liquid discharge heads 100 in total (100Ka, 100Kb, 100Ya, 100Yb, 100Ma, 100Mb, 100Ca, and 100Cb).

As will be used herein, a Y direction is defined as a direction parallel with and opposite from the direction A of conveyance of the medium M, a Z direction is defined as a direction from the liquid discharge head 100 to the medium M, and an X direction is defined as a direction perpendicular to both the Y direction and the Z direction and perpendicular to the direction A of conveyance of the medium M.

### 1.2 Configuration of Liquid Discharge Head

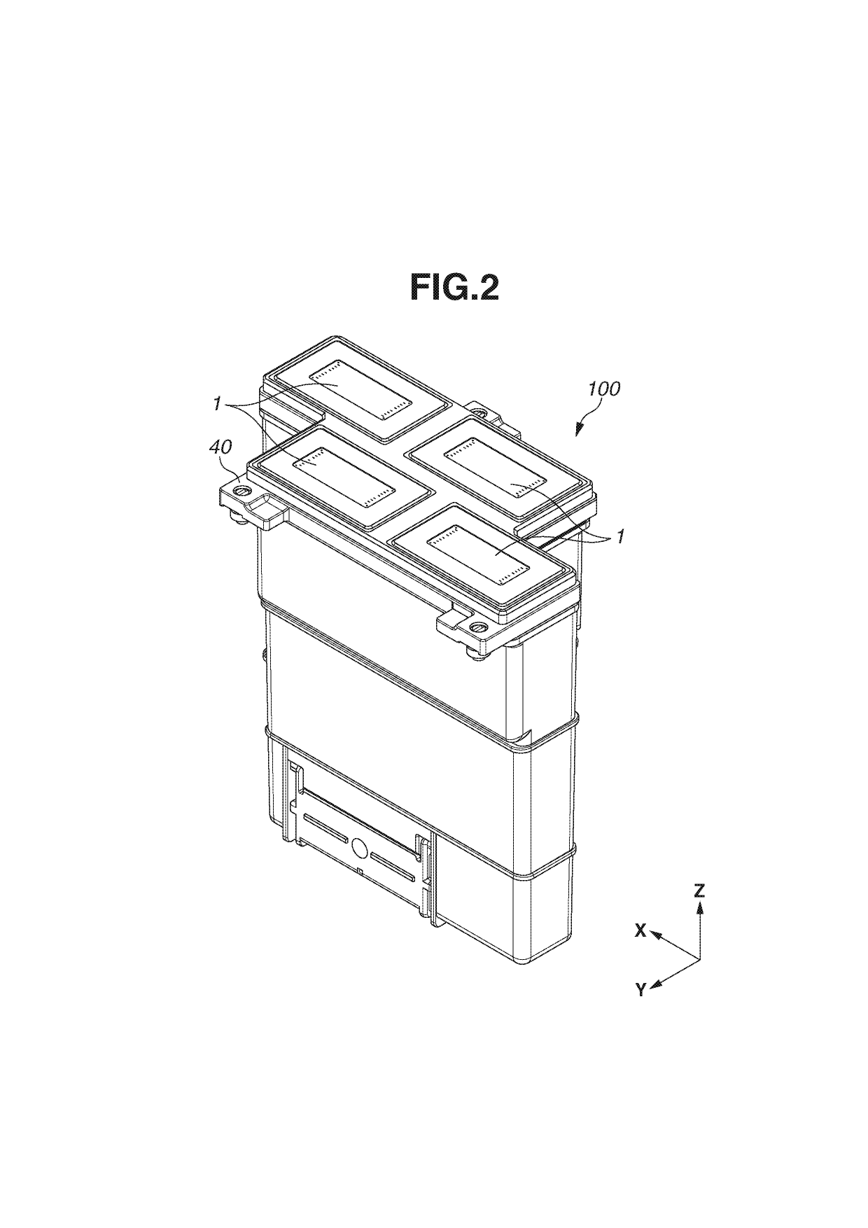

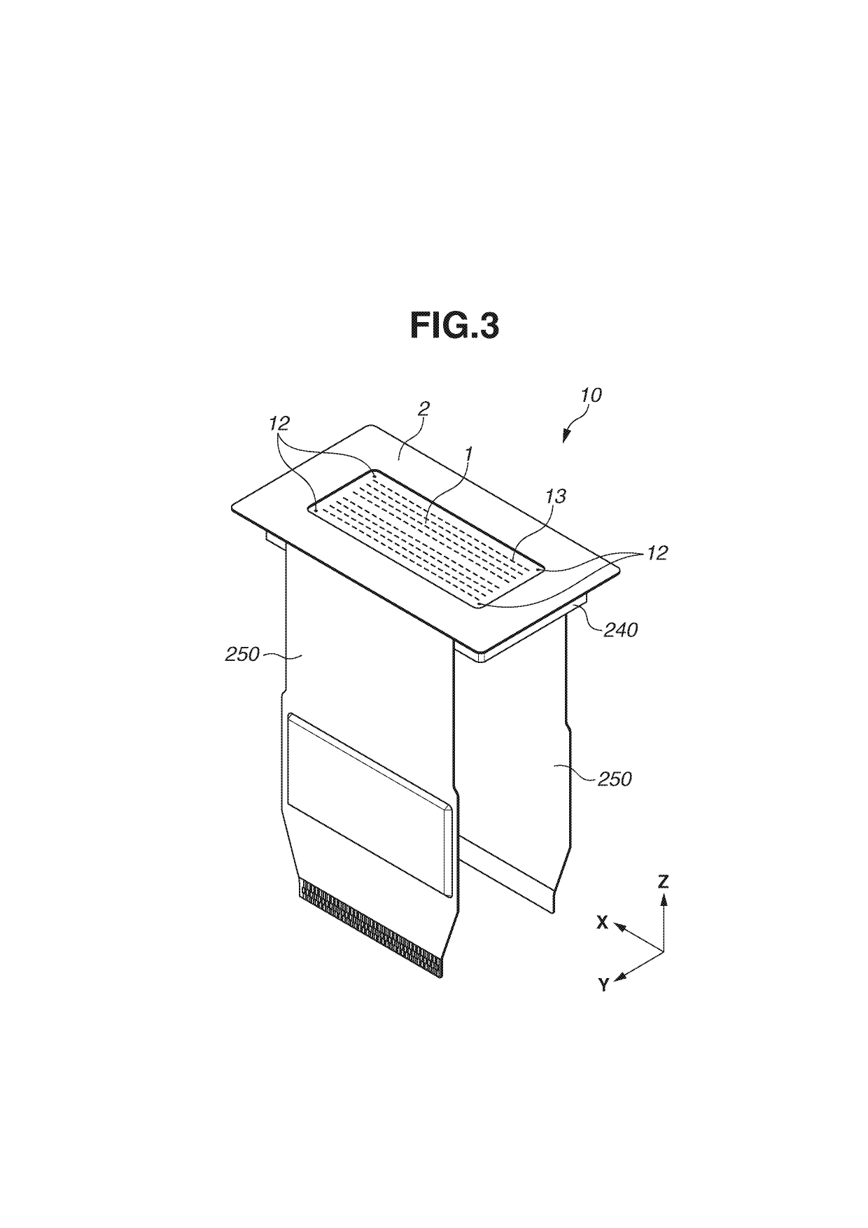

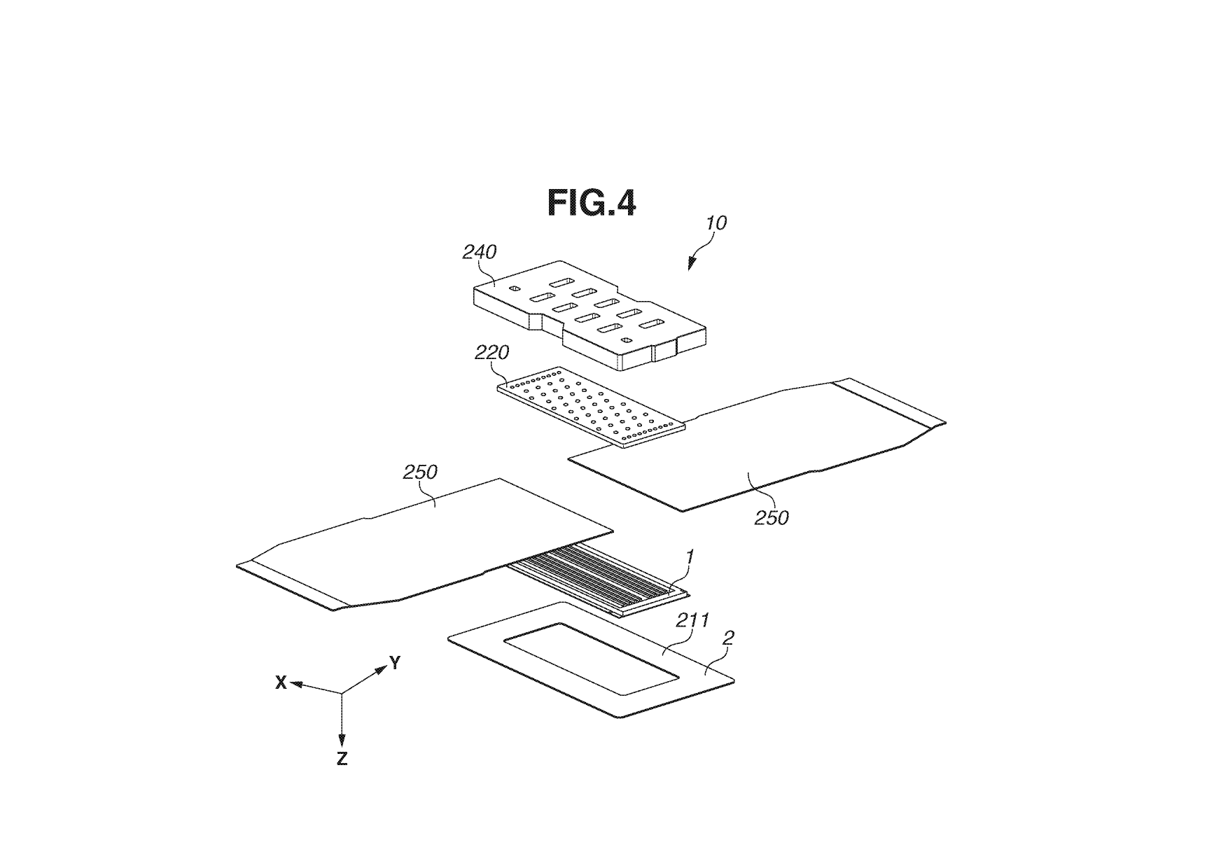

FIG. 2 illustrates a perspective view of a liquid discharge head 100, and FIG. 3 illustrates a perspective view of a liquid discharge unit 10. The liquid discharge head 100 according to the present embodiment includes a plurality of liquid discharge units 10 fixed on the support member 40. Each of the liquid discharge units 10 includes the discharge chip 1 having discharge ports for discharging the liquid therein. A cover member 2 is provided on a joint surface 111 of the liquid discharge unit 10, which is the opposite surface of the discharge chip 1 from the support member 40 (refer to FIGS. 3 and 4). The cover member 2 is joined to the joint surface 111 of the discharge chip 1 on a joint surface (a first surface) 211. Further, the liquid discharge head 100 includes a housing that houses an electric circuit board and the like. The liquid discharge head to which the present disclosure is applicable can be implemented in any form including the example illustrated in FIG. 2, and the other forms are also not limited thereto.

### 1.3 Configuration of Liquid Discharge Unit

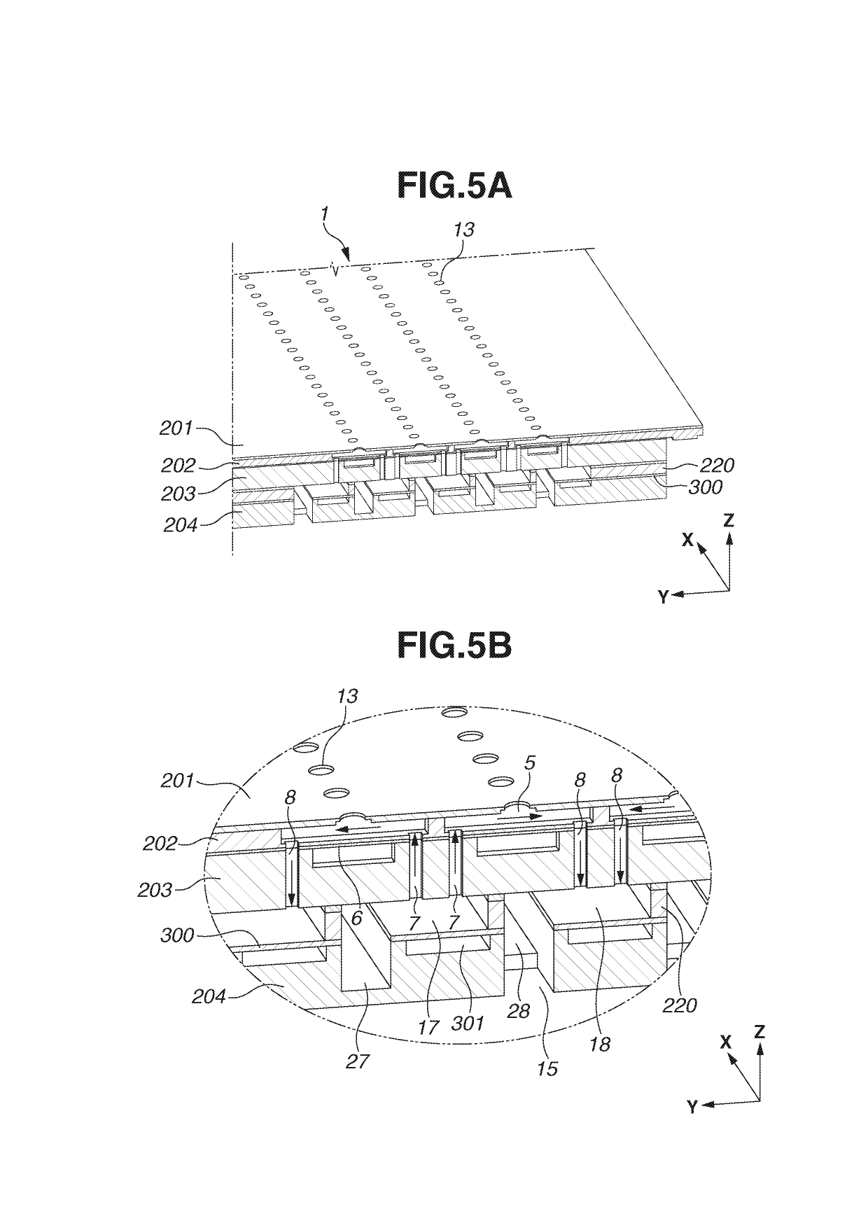

FIG. 4 illustrates an exploded perspective view of a liquid discharge unit 10 as viewed from the opposite side from the surface where the discharge ports 13 in the discharge chip 1 are provided (the front surface). The liquid discharge unit 10 includes the discharge chip 1, electric wiring members (wiring substrates) 250, a damper substrate 220, which supplies liquid to the discharge chip 1, and a flow path member 240. The discharge chip 1 includes the discharge ports 13 for discharging the liquid, piezoelectric elements (refer to FIGS. 5A and 5B) serving as actuators for discharging the liquid from the discharge ports 13, and terminals (not illustrated) electrically connected to the actuators. The electric wiring members 250 are connected to the terminals to supply, from outside the discharge chip 1, power for driving the actuators to the pressure generation elements included in the actuators. The damper substrate 220 and the flow path member 240 have flow paths for supplying the liquid to the discharge ports 13, and are disposed adjacent to the discharge chip 1 on a back surface opposite from the front surface of the discharge chip 1. The electric wiring members 250 are connected to the terminals included in the discharge chip 1 to form electric connection portions on the back surface side of the discharge chip 1.

In the present embodiment, the liquid discharge unit 10 further includes the cover member 2 for protecting the front surface of the discharge chip 1. In the present embodiment, alumina and titanium are used for the flow path member 240 and the cover member 2, respectively, as an example.

### 1.4 Configuration of Liquid Discharge Substrate

FIGS. 5A and 5B illustrate a discharge chip 1 according to the present embodiment. FIG. 5A illustrates a cross-sectional view in a YZ plane. FIG. 5B is an enlarged view illustrating part around the discharge ports 13 illustrated in FIG. 5A.

The discharge chip 1 according to the present embodiment is formed in a laminated structure of a plurality of substrates as illustrated in FIG. 5A. Specifically, the discharge chip 1 includes five substrates, i.e., a discharge port formation substrate 201, a vibration substrate 202, a liquid supply substrate 203, a flow path formation substrate 204, and the damper substrate 220. The discharge chip 1 is formed by bonding the damper substrate 220 including a damper member 300 between the flow path formation substrate 204 and the liquid supply substrate 203.

The discharge chip 1 according to the present embodiment will be described in detail with reference to FIG. 5B. Pressure chambers 5 in communication with the discharge ports 13 are formed in the discharge chip 1. A pressure chamber 5 is formed for each discharge port 13. Further, in each pressure chamber 5, a piezoelectric element 6 is provided on a deformable wall surface formed of the vibration substrate 202. The piezoelectric element 6 can pressurize the liquid in the pressure chamber 5 by deforming the vibration substrate 202, causing the ink to be discharged from the discharge port 13.

An individual supply flow path 7 and an individual collection flow path 8, each of which is in communication with a pressure chamber 5, are formed for each pressure chamber 5 on the liquid supply substrate 203. The ink is supplied from the individual supply flow paths 7 to the pressure chambers 5 to be discharged from the discharge ports 13. Further, some of the ink can flow from the pressure chambers 5 to the individual collection flow paths 8. In other words, in the configuration according to the present embodiment illustrated in FIGS. 5A and 5B, two individual flow paths (the individual supply flow path 7 and the individual collection flow path 8) are connected to one pressure chamber 5, allowing the liquid, such as the ink, to be circulated inside and outside the pressure chamber 5.

A plurality of individual supply flow paths 7 communicates with a first common supply flow path 17 formed on the damper substrate 220. A plurality of individual collection flow paths 8 communicates with a first common collection flow path 18 formed on the damper substrate 220. A wall surface of a first common supply flow path 17 that faces the individual supply flow paths 7 is formed of the damper member 300. A damper region 301 is provided at a position facing the individual supply flow paths 7. A wall surface of the first common collection flow path 18 that faces the individual collection flow paths 8 is formed of the damper member 300. A damper region 301 is provided at a position facing the individual collection flow paths 8. The damper regions 301 are regions of the wall surface formed of the damper member 300, which form recessed spaces provided in the flow path formation substrate 204. When pressure changes, the damper member 300 can absorb the pressure using the recessed space provided in the flow path formation substrate 204. The first common supply flow paths 17 and the first common collection flow paths 18 extend in a longitudinal direction of the discharge chip 1. Further, the plurality of first common supply flow paths 17 and the plurality of first common collection flow paths 18 are formed so as to be alternately arranged in a short-side direction of the discharge chip 1.

Each first common supply flow path 17 communicates with a second common supply flow path 27 formed in the flow path formation substrate 204. A plurality of connection flow paths 15 is formed in the second common supply flow path 27. The ink is supplied from outside the discharge chip 1 via the connection flow paths 15. Each first common collection flow path 18 communicates with a second common collection flow path 28 formed in the flow path formation substrate 204. A plurality of connection flow paths 15 is formed in the second common collection flow path 28. The ink is collected to the outside of the discharge chip 1 through the connection flow paths 15. The second common supply flow paths 27 and the second common collection flow paths 28 extend in the longitudinal direction of the discharge chip 1. Further, the plurality of second common supply flow paths 27 and the plurality of second common collection flow paths 28 are formed so as to be alternately arranged in the short-side direction of the discharge chip 1. As illustrated in FIG. 5B, the first common supply flow path 17 and the second common supply flow path 27 integrally form a common supply flow path. Similarly, the first common collection flow path 18 and the second common collection flow path 28 integrally form a common collection flow path.

The discharge port formation substrate 201, the vibration substrate 202, the liquid supply substrate 203, the flow path formation substrate 204, and the damper substrate 220 can be each made of a silicon substrate or the like. Further, in the present embodiment, the example is described in which these substrates are separate substrates, but these substrates are not limited to the separate substrates. The damper member 300 is made of an elastic member, and can be formed using a resin member, such as polyimide or polyamide. Examples of a method for forming the openings in the damper member 300 include dry etching. Further, in a case where the damper member is photosensitive resin, the damper member can be patterned by exposure.

In this manner, the discharge chip 1 includes a first substrate (the discharge port formation substrate 201) in which the discharge ports 13 are formed, a second substrate (the vibration substrate 202) in which the pressure chambers 5 are formed, and a third substrate (the liquid supply substrate 203) in which the individual supply flow paths 7 and the individual collection flow paths 8 are formed. Further, the discharge chip 1 includes the damper member 300, a fourth substrate (the damper substrate 220) in which the first common supply flow paths 17 and the first common collection flow paths 18 are formed, and a fifth substrate (the flow path formation substrate 204) in which the second common supply flow paths 27 and the second common collection flow paths 28 are formed. These substrates are stacked in the order of the first substrate (the discharge port formation substrate 201), the second substrate (the vibration substrate 202), the third substrate (the liquid supply substrate 203), the fourth substrate (the damper substrate 220), and the fifth substrate (the flow path formation substrate 204).

### 2. Joining of Members

### 2.1 Overview of Joining Procedure

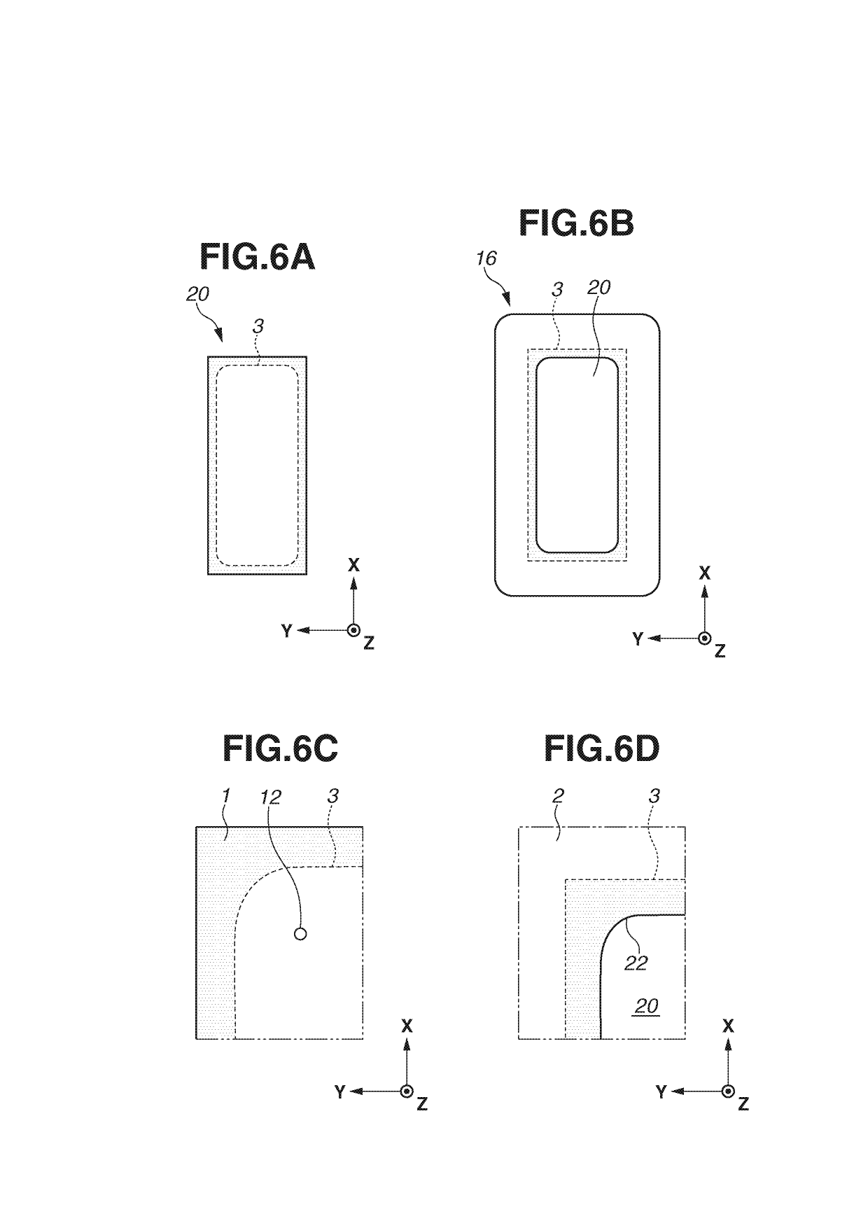

In the following description, joining of a discharge chip 1 and a cover member 2 will be described as an example of joining of members to which the present disclosure is applied. FIGS. 6A and 6B illustrate members to be joined according to the present embodiment. FIG. 6A illustrates the discharge chip 1, and FIG. 6B illustrates the cover member 2. Regions indicated by dotted lines in FIGS. 6A and 6B are each a joining region 3. A large number of discharge ports 13 are disposed at the central portion of the front surface of the discharge chip 1, and the liquid is discharged from those discharge ports 13 in the liquid discharge head 100. Further, the cover member 2, which is a plate-like member having a square shape with an opening 20 formed at the central portion, circumvents the discharge ports 13, allowing the area of the discharge chip 1 around the discharge ports 13 to be protected with the discharge ports 13 exposed through the opening 20 during joining. In the following description, it is assumed that the surfaces of the discharge chip 1 and the cover member 2 joined to each other with an adhesive 4 lies in an XY plane, and the Z direction is perpendicular to the XY plane and a direction where force is applied at the time of the joining.

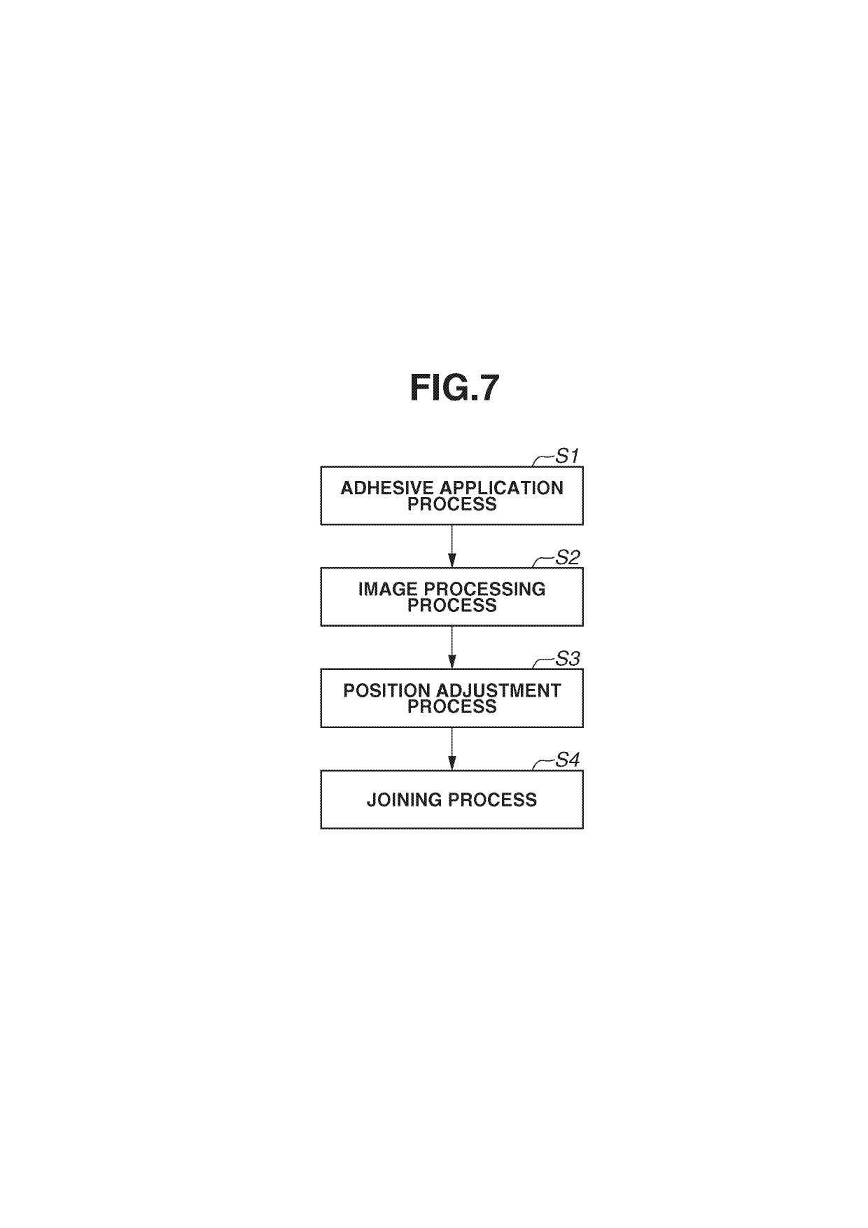

An overview will now be described of the procedure of joining the discharge chip 1 and the cover member 2. FIG. 7 illustrates the procedure of the process for joining the discharge chip 1 and the cover member 2. As illustrated in FIG. 7, the joining includes an adhesive application process S1, an image processing process S2, a position adjustment process S3, and a joining process S4. First, in the adhesive application process S1, the adhesive 4 is applied to the joining region 3 of the discharge chip 1. It is desirable to apply an amount of the adhesive 4 that will not protrude into the inside of the opening 20 of the cover member 2 after joining. Next, in the image processing process S2, the image processing is performed. The image processing process will be described below. After that, in the position adjustment process S3, the position of the cover member 2 is adjusted with respect to the discharge chip 1 on the XY plane based on the result of the image processing process. Subsequently, in the joining process S4, the adhesive 4 is thermally cured with the cover member 2 aligned with the discharge chip 1 to fix the discharge chip 1 and the cover member 2.

In the adhesive application process S1, the adhesive 4 can be applied to the cover member 2 instead of being applied to the discharge chip 1. Further, the method of curing the adhesive 4 may be ultraviolet (UV) curing, moisture curing, or the like other than thermal curing.

### 2.2 Regarding Image Processing

The image processing process S2 will now be described for the discharge chip 1 and the cover member 2. FIGS. 6A to 6D illustrate detection portions detected by an imaging apparatus, such as a camera, at the time of image processing. FIGS. 6C and 6D are enlarged views of the discharge chip 1 and the cover member 2, respectively.

First, an alignment mark 12 is provided on the discharge chip 1 at a position that does not overlap with the joining region 3 in a planar view. The alignment mark 12 is circular in FIG. 6C, but may be any asymmetric shape in light of orientation detection. For example, by combining a circle shape with a rectangle shape, different patterns of alignment marks can be provided at the four corners of the discharge chip 1. This makes it possible to prevent the discharge chip 1 from being joined to the cover member 2 with the discharge chip 1 rotated 180 degrees. This also makes it possible prevent discharge chips for different models of liquid discharge heads from being mixed in. Further, a discharge nozzle or the like may be used as a positioning reference instead of the alignment mark. The alignment mark 12 is omitted in FIG. 6A.

For the cover member 2, an edge 22 of the opening 20 is used as a detection portion at the time of image processing. The corner of the edge 22 of the cover member 2 has a rounded shape in FIG. 6D, but may have a rectangular shape or a C-like shape. Further, only the upper left portions of the respective components are illustrated in FIGS. 6C and 6D. However, the discharge chip 1 and the cover member 2 according to the present embodiment have shapes that are symmetrical in both the vertical and horizontal directions, and thus, similar detection portions for image processing are also present at the other three corners.

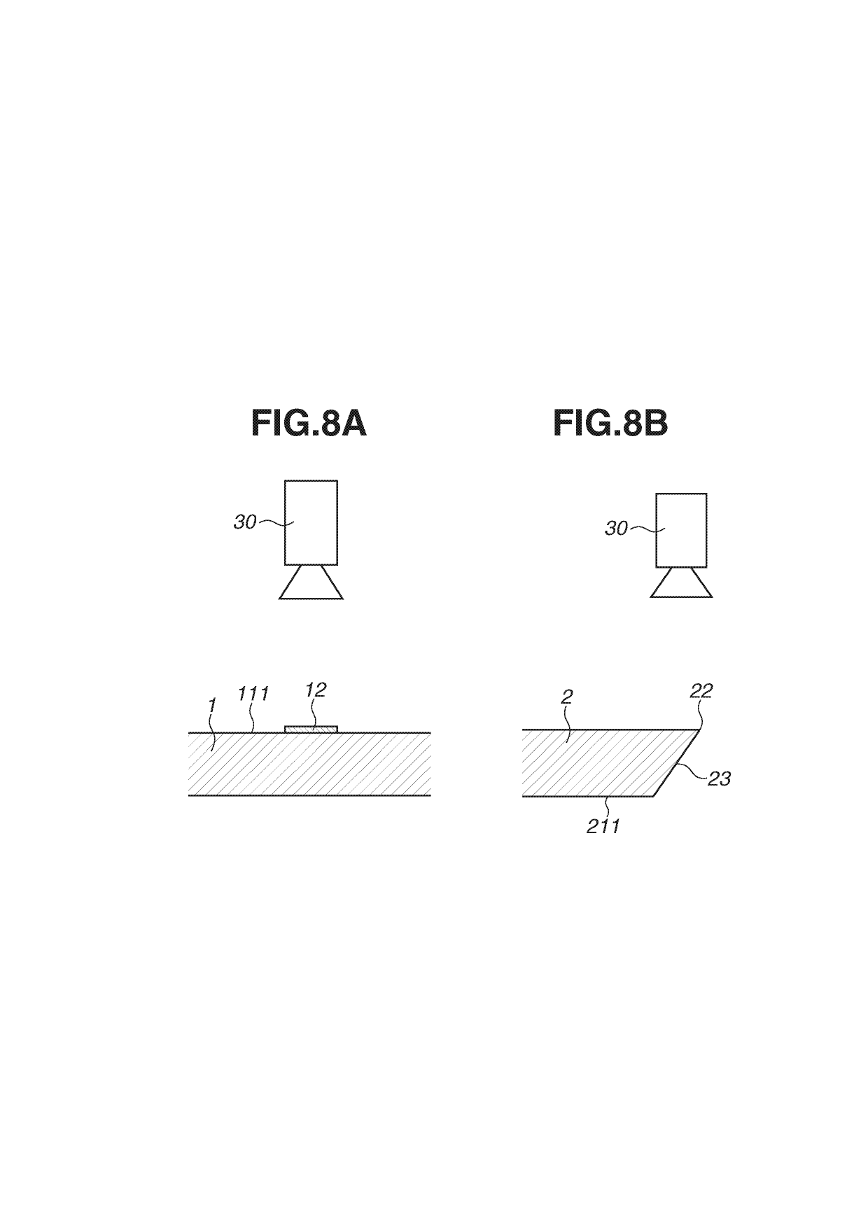

FIGS. 8A and 8B each illustrate positions of a camera 30 in the image processing process S2. FIG. 8A illustrates a cross-section of the discharge chip 1 and a position of the camera 30, and FIG. 8B illustrates a cross-section of the cover member 2 and another position of the camera 30. A camera is used to image the detection portions in the present embodiment, but the present disclosure can be applied using an imaging apparatus or the like other than a camera. First, the discharge chip 1 is imaged by the camera 30 positioned in the same direction as the joint surface 111 of the chip member. Further, the cover member 2 is imaged by the camera 30 positioned in the opposite direction from the joint surface 211 of the cover member 2. After that, the positions of the alignment mark 12 and the edge 22 are detected by the captured images of the discharge chip 1 and the cover member 2 being processed, respectively, to calculate the coordinates of the discharge chip 1 and the cover member 2. In the present embodiment, the discharge chip 1 and the cover member 2 are put on different stages of a joining apparatus, respectively, when being imaged by the camera 30, and then the positions of the stages are adjusted based on the coordinate information acquired from the images at the time of pickup and mounting of the cover member 2 onto the discharge chip 1.

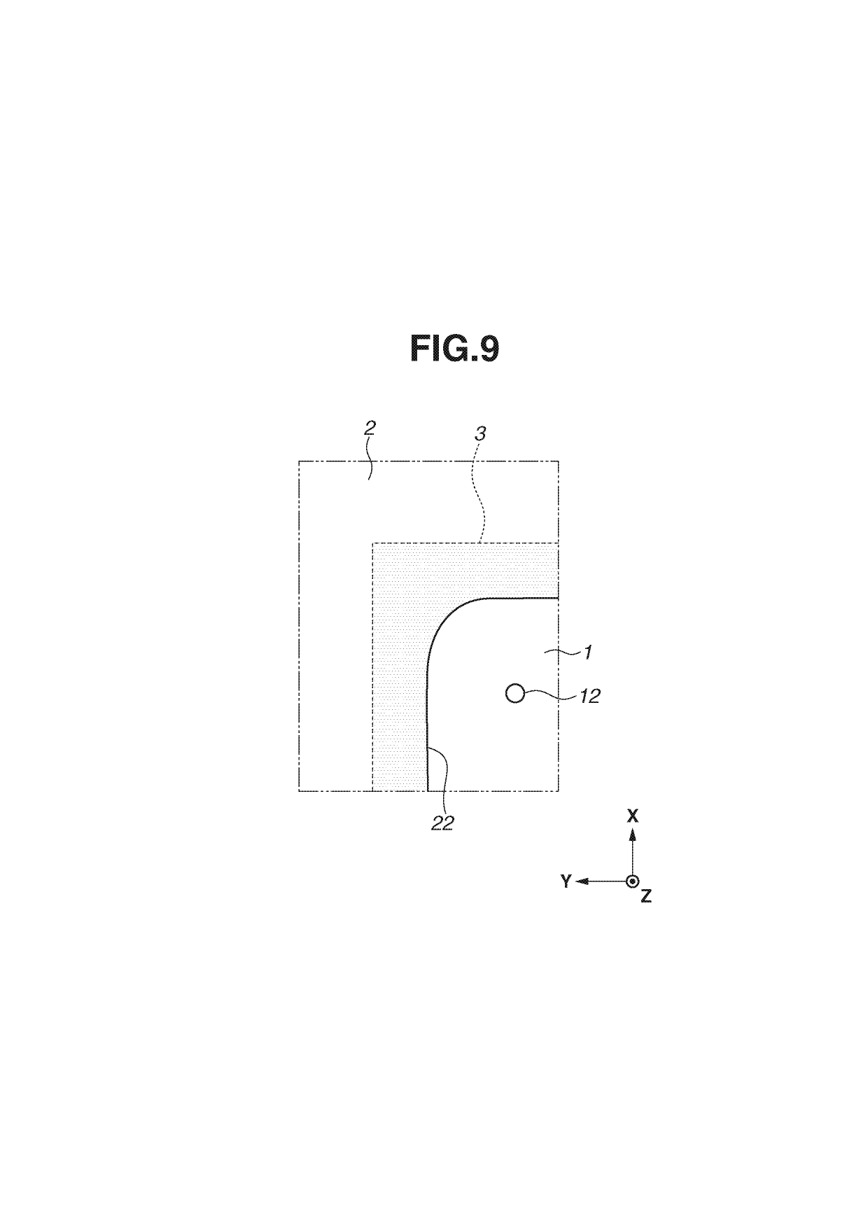

The relative positions will now be described of the alignment mark 12 of the discharge chip 1 and the edge 22 of the cover member 2 in the XY plane after joining. FIG. 9 is an enlarged view of the positional relationship after the discharge chip 1 and the cover member 2 are joined. In manufacturing the liquid discharge head 100 according to the present embodiment, the alignment mark 12 and the edge 22 are arranged so that the alignment accuracy after joining can be measured and guaranteed. Thus, it is desirable for the edge 22 positioned in both the X direction and the Y direction and the alignment mark 12 to be close to each other as illustrated in FIG. 9. It is desirable for the distance between the edge 22 and the alignment mark 12 in the XY plane to be one millimeter (mm) or shorter in both the X direction and the Y direction. A shorter distance between the edge 22 and the alignment mark 12 facilitates more accurate measurement of the relative positions.

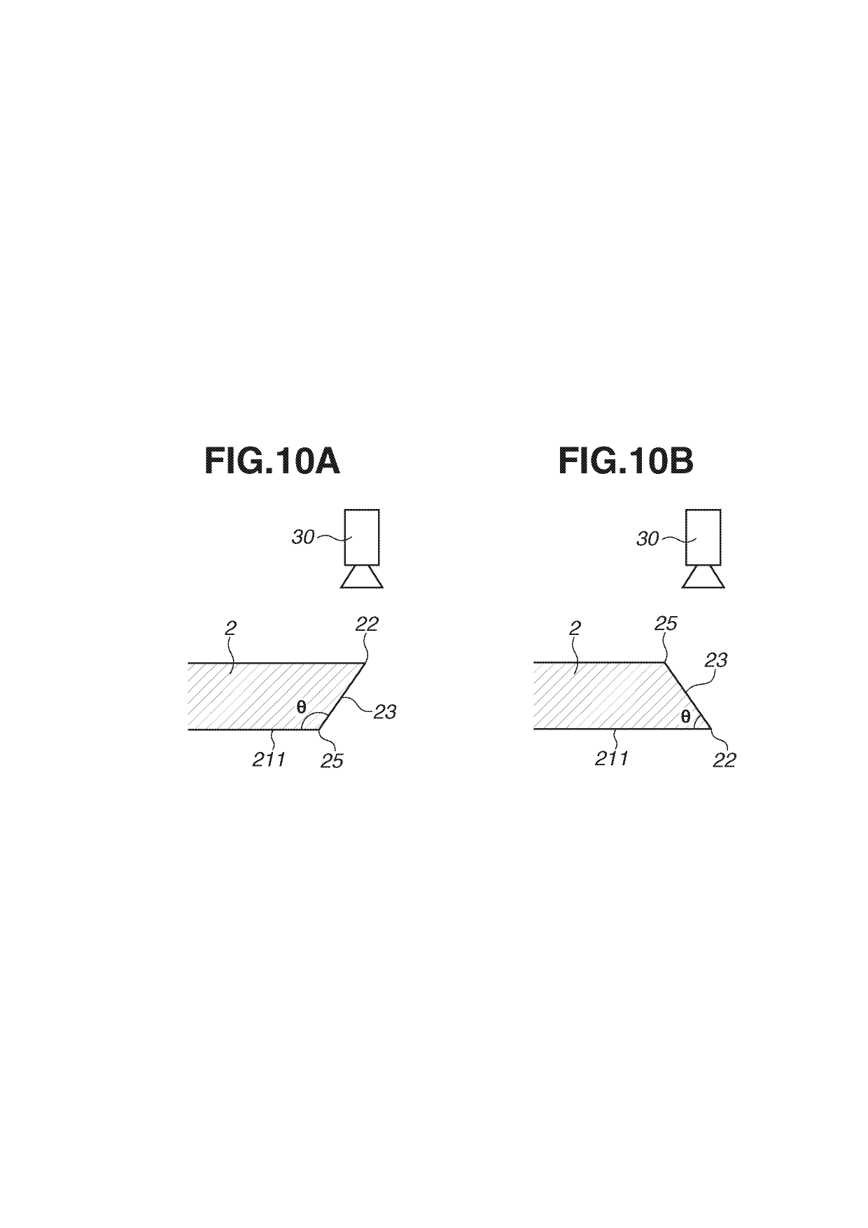

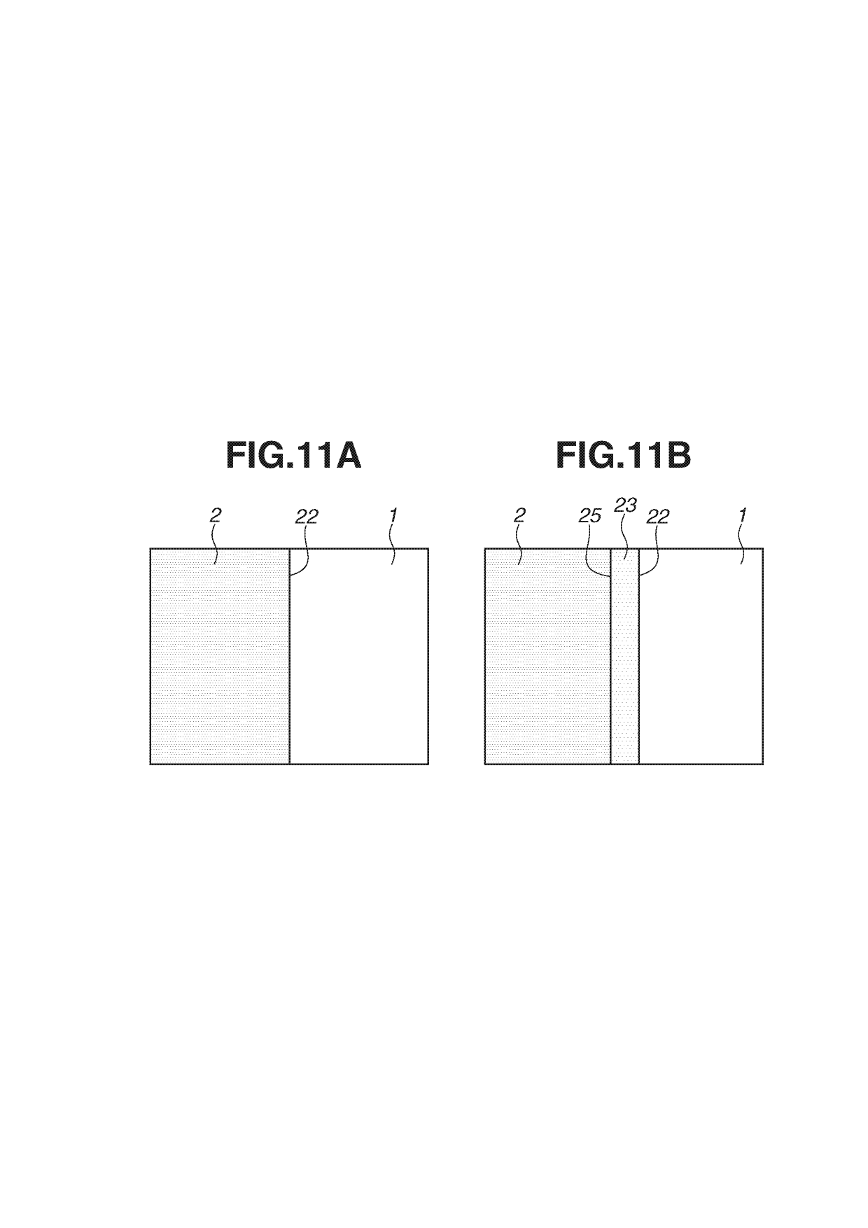

The detection of the edge 22 of the cover member 2 in the image processing process S2 will be described. As described above, the cover member 2 is imaged from the opposite surface (the second surface) side from the joint surface 211, and thus, the detection of the edge 22 is significantly affected by the surrounding shape. Cross-sections of the cover member 2 and positions of the camera 30 will be described with reference to FIGS. 10A and 10B. The cover member 2 illustrated in FIG. 10A has a cross-sectional shape according to the present embodiment, and the edge 22, which is an end edge on the opposite side from the joint surface 211, protrudes. On the other hand, the cover member 2 illustrated in FIG. 10B has a cross-sectional shape according to a comparative example, and an end edge on the joint surface 211 protrudes. Further, FIGS. 11A and 11B are illustrative views of captured images corresponding to the cases of FIGS. 10A and 10B, respectively.

First, in a case where the cover member 2 has the shape as illustrated in FIG. 10A, the boundary line of the opening 20 is only a single line indicating the edge 22 in the captured image as illustrated in FIG. 11A, and thus, the likelihood is reduced of erroneous detection in the edge detection using the image processing. In this manner, in the cover member 2, the edge (the edge 22) that protrudes more in the XY plane should be detected. On the other hand, in a case where the cover member 2 has the shape as illustrated in FIG. 10B, two lines are detected as the boundary line of the opening 20 in the captured image illustrated in FIG. 11B. This is because an internal side surface 23 of the cover member 2 faces in the direction toward the camera 30, and thus, an edge 25 that should not be detected is also imaged in the captured image, as well as the edge 22 that should be detected. In this manner, in the shape illustrated in FIG. 10B, the boundary line of the opening 20 appears as two lines in the captured image, which increases the likelihood of erroneous detection of the edge 25 that should not be detected by the image processing. Especially, in the liquid discharge unit 10 according to the present embodiment, the discharge chip 1 and the cover member 2 are made of silicon and titanium, respectively, both of which are metallic material. Consequently, the colors in the captured image closely resemble, making it more difficult to distinguish between those two. Thus, the effect of the present disclosure can be significantly exhibited.

As described above, the cover member 2 according to the present embodiment has the protruding edge on the opposite side from the joint surface 211 in a thickness direction, enabling reliable detection of the edge 22 that should be detected. In other words, when the component to be joined is imaged from above by the camera 30 and subjected to the image processing, the edge 22 does not appear duplicated in the image. Thus, the position of the component can be stably detected, and erroneous detection can be prevented.

Further, in the present embodiment, no alignment mark is provided on the cover member 2 positioned at the outermost surface of a liquid discharge head, and alignment during joining is performed using the edge 22. This makes it possible to prevent decrease in the wiping performance or the like due to the irregularities in the cover member 2 at the time of cleaning the head surface.

### 2.3 Method for Processing Cover Member 2

In the present embodiment, the inclined internal side surface 23 of the opening 20 in the cover member 2 allows the edge 22 positioned on the camera 30 side to protrude beyond the edge 25 in the XY plane. The method will now be described for processing the cover member 2. The cover member 2 serves to protect the discharge ports 13 and has a relatively small thickness. The cover member 2 according to the present embodiment is made of metal. Any method, such as punching a sheet-like material, etching, or machining, can be used as the processing method for the cover member 2.

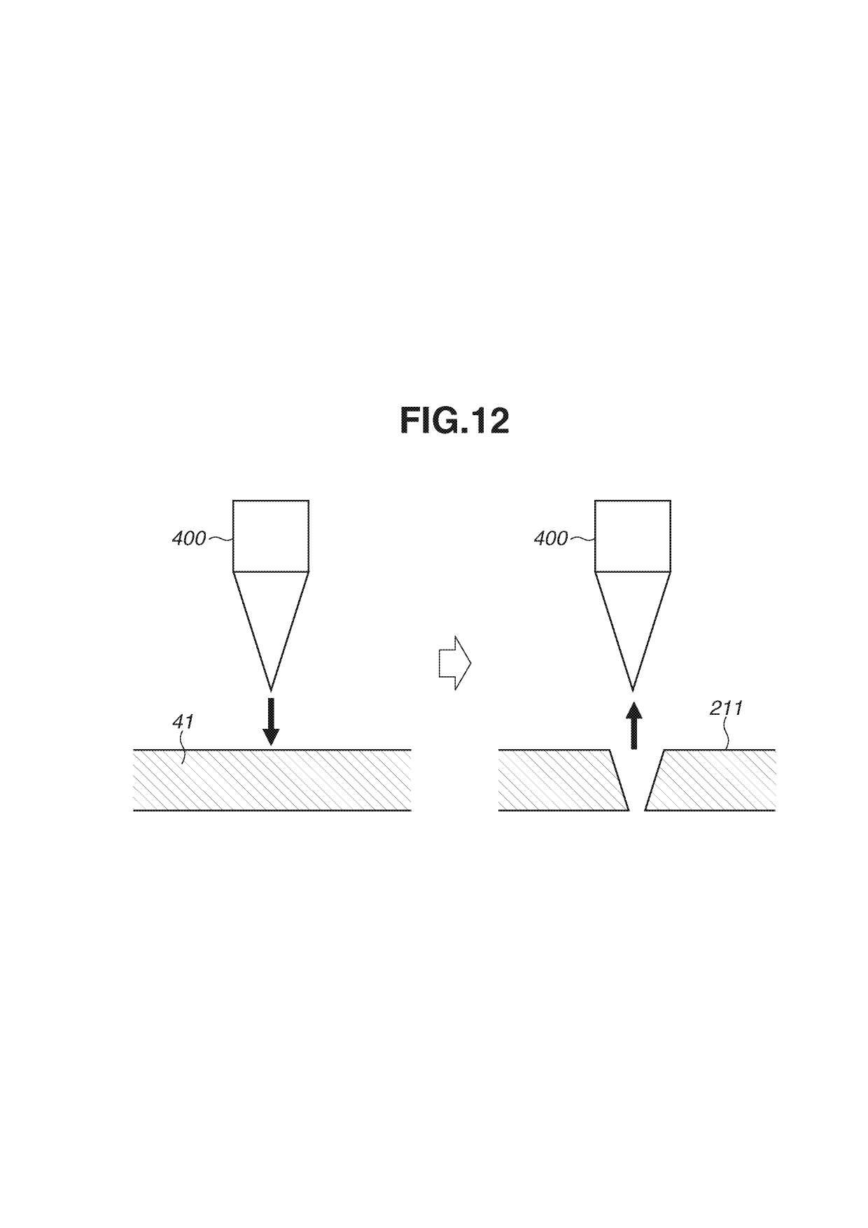

FIG. 12 illustrates a part of a process of shaping the cover member 2 using the punching method. As illustrated in FIG. 12, a blade 400 is lowered in the Z direction to break a raw material 41. As a result, the cover member 2 has a shape in which the lower side of the raw material 41 protrudes. The cover member 2 according to the present embodiment can be formed by using the surface on the side where the blade enters as the joint surface 211. The angle of the cut surface with respect to the joint surface 211 can be changed depending on the shape of the cutting blade and the cutting conditions.

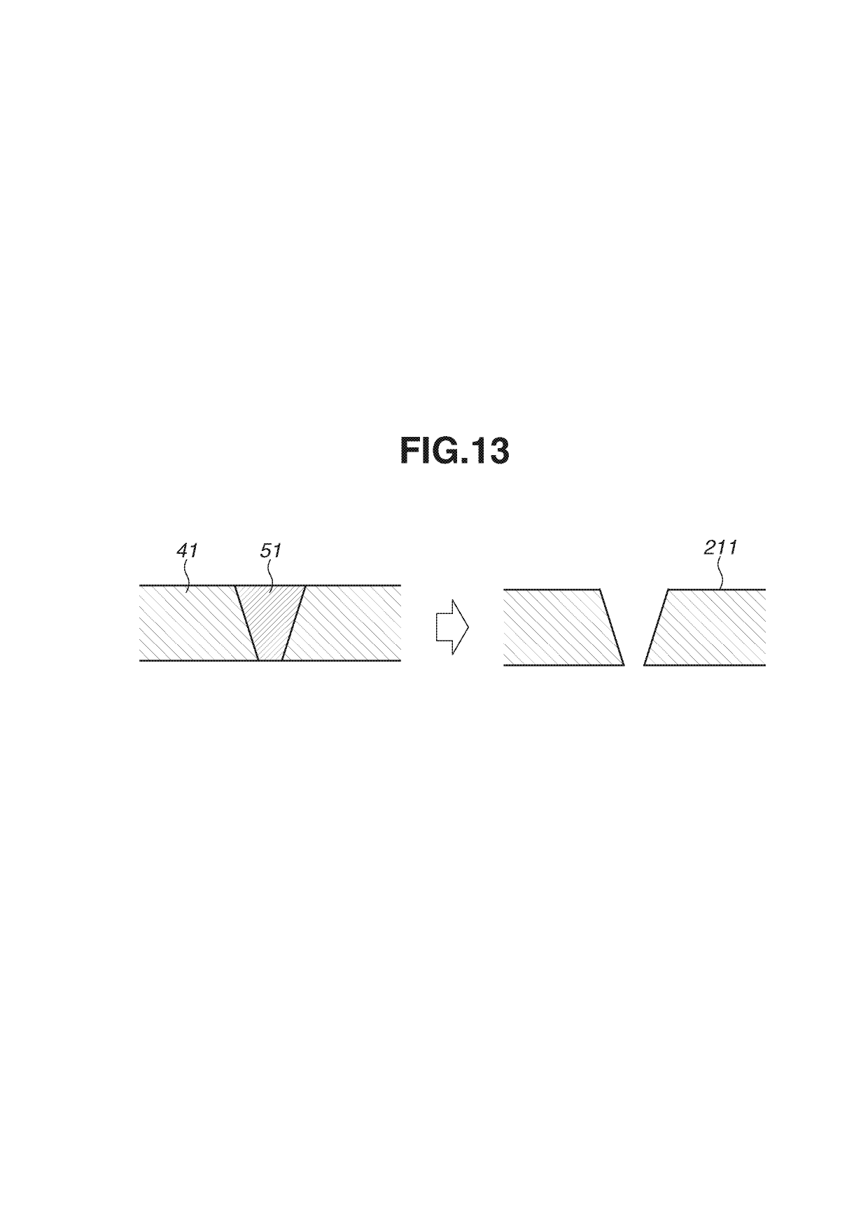

FIG. 13 illustrates a part of a process of shaping the cover member 2 using etching. In the case of the etching, as illustrated in FIG. 13, a removal region 51 at the time of the cutting has a shape in which the removal width gradually tapers in the thickness direction starting from a processing surface. As a result, the cover member 2 has a shape in which the opposite surface from the processing surface protrudes. Thus, the cover member 2 according to the present embodiment can be formed by using the surface on the same side as the processing surface as the joint surface 211. Further, the angle of the side surface 23 with respect to the joint surface 211 can be changed depending on the conditions of the etching. In a case where the cover member 2 is formed by machining, the shape of the internal side surface 23 of the cover member 2 can be controlled in a desired manner. Thus, the cover member 2 according to the present embodiment can be formed through the processing so that the end edges opposite from the joint surface 211 protrudes at the time of machining. The method for processing the cover member 2 is not limited to the above-described methods, and the cover member 2 can be formed by any desired method.

### 2.4 Regarding Angle between Joint Surface and Internal Side Surface

A relative angle θ between the joint surface 211 and the internal side surface 23 of the cover member 2 according to the present embodiment will be described. In the present embodiment, the purpose is to make the detected boundary line of the opening 20 a single line in the image captured by the camera 30, and thus, the relative angle θ between the joint surface 211 and the internal side surface 23 of the cover member 2 is larger than 90 degrees. It is desirable for the relative angle θ to be 95 degrees or larger. On the other hand, if the relative angle θ is too large, i.e., if the protruding portion becomes too sharp, the area of the joint surface 211 cannot be sufficiently secured, resulting in failure to achieve the original purpose of protecting the discharge ports 13. For this reason, it is desirable for the angle θ at which the joint surface 211 and the internal side surface 23 of the cover member 2 intersect with each other be in the range of 90 degrees to 150 degrees, and it is more desirable for the angle to be in the range of 95 degrees to 150 degrees.

### 2.5 Regarding State of Liquid Discharge Head after Adhesive is Cured

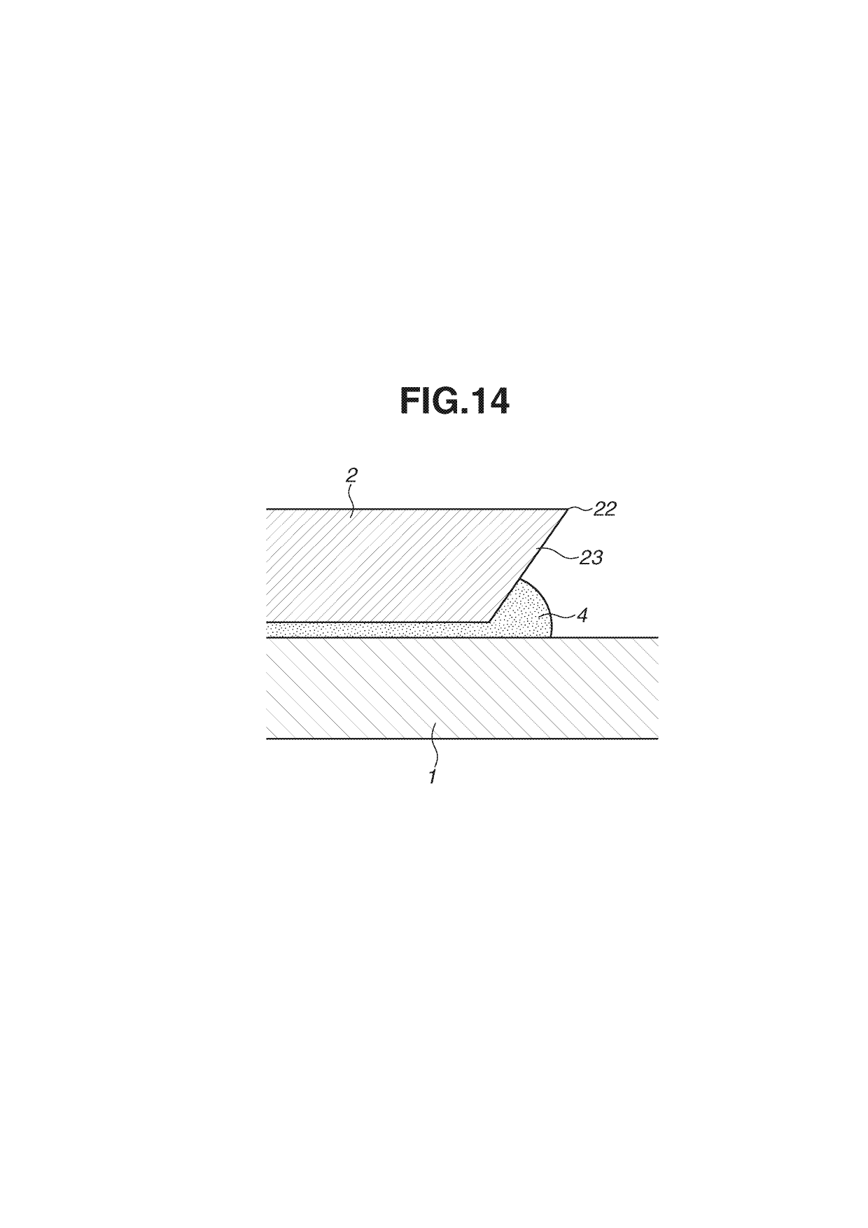

The configuration according to the present embodiment also has an advantage in terms of protrusion of the adhesive 4 in the state after the adhesive 4 is cured. FIG. 14 illustrates a cross-sectional view of the discharge chip 1 and the cover member 2 after the adhesive 4 is cured.

As illustrated in FIG. 14, the cover member 2 according to the present embodiment has a shape in which the internal side surface 23 of the opening 20 is inclined inward (to the discharge-port side). Thus, even if the adhesive 4 ever protrudes from the joining region 3 in the XY plane, the protruded adhesive 4 remains in the region between the internal side surface 23 and the discharge chip 1, which prevents the adhesive 4 from protruding inward (to the discharge-port side) beyond the edge 22 of the cover member 2. Protrusion of the adhesive 4 inward beyond the edge 22 may adhere to the discharge ports 13, affecting the discharge performance. Thus, the present embodiment can be regarded as having an advantage also from this viewpoint.

As described above, according to the present disclosure, by forming the edge shape of the opening 20 in the cover member 2 into an inverted taper shape with the liquid discharge direction oriented upward, erroneous detection of edges can be prevented at the time of image processing, providing highly accurate alignment between the members.

### 3. Other Embodiments

The first surface of the cover member may be configured to be directly joined to the discharge chip using an intermediate member in addition to the adhesive.

Further, a configuration can be employed where both the discharge chip and the cover member are joined on the same surface of a single support member.

The disclosed matters described in the above-described embodiment include the following configurations and manufacturing methods for the liquid discharge head.

The present disclosure will now be described in detail referring to a specific example. However, the present disclosure is not limited to the following example.

### Example

The present example is an example of a manufacturing method for the liquid discharge head according to the above-described embodiment. The discharge chip 1 illustrated in FIGS. 2 to 5 was prepared. The thickness (the size in the Z direction) of the discharge chip 1 is 1 mm, the width (the size in the Y direction) is 13 mm, and the length (the size in the X direction) is 29 mm. Further, as the cover member 2, a titanium cover member 2 having a thickness of 100 micrometers (μm) of which an outer shape has a width (the size in the Y direction) of 22 mm and a length (the size in the X direction) of 39 mm and an opening 20 has a width of 11 mm and a length of 27 mm was prepared. Further, the side surface 23 of the opening 20 in the cover member 2 has a shape in which the edge 22 on the opposite side from the joint surface 211 protrudes by 80 μm in the XY plane with respect to the edge 25 on the joint surface 211 side. The angle θ is approximately 129 degrees. In accordance with the procedure illustrated in FIGS. 6A to 6D, the discharge chip 1 and the cover member 2 were aligned by image processing and were joined using a thermally curable adhesive. After that, when the alignment accuracy was measured, the misalignment between the central positions of the discharge chip 1 and the cover member 2 was within 20 μm in both the X and Y directions.

### Comparative Example

The dimensions of the discharge chip 1 and the cover member 2 according to the comparative example were the same as those of the example. However, the side surface 23 of the opening 20 in the cover member 2 has a shape in which the edge 25 on the joint surface 211 side protrudes by 80 μm in the XY plane with respect to the edge 22 on the opposite side from the joint surface 211. The angle θ is approximately 51 degrees. In accordance with the procedure illustrated in FIGS. 6A to 6D, the discharge chip 1 and the cover member 2 were aligned by image processing and were joined using a thermally curable adhesive. After that, when the alignment accuracy was measured, the misalignment between the central positions of the discharge chip 1 and the cover member 2 was larger than that of the example, reaching 100 μm in both the X and Y directions.

According to the present disclosure, a liquid discharge head with members highly accurately aligned with each other and a method for manufacturing the liquid discharge head can be provided.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of priority from Japanese Patent Application No. 2024-210521, filed December 3, 2024, which is hereby incorporated by reference herein in its entirety.

What is claimed is:

1. A liquid discharge head comprising:
a discharge chip including a discharge port for discharging liquid; and
a cover member having an opening for exposing the discharge chip, the cover member including a first surface which is joined to the discharge chip with adhesive, and a second surface opposite from the first surface,
wherein, at least in a part of the opening as viewed from a direction perpendicular to the second surface, an edge on the second surface side is positioned inside the opening with respect to an edge on the first surface side.

2. The liquid discharge head according to claim 1, wherein a side surface of the opening has an inverted taper shape in the cover member.

3. The liquid discharge head according to claim 2, wherein an angle at which the first surface and the side surface of the opening intersect with each other is greater than 95 degrees and equal to or less than 150 degrees in the cover member.

4. The liquid discharge head according to claim 1, wherein the cover member is positioned at an outermost surface of the liquid discharge head in a direction in which the liquid is discharged from the discharge port.

5. The liquid discharge head according to claim 1, wherein both the discharge chip and the cover member are made of metal.

6. The liquid discharge head according to claim 1, wherein the cover member covers at least a part of the discharge chip as viewed from the direction perpendicular to the second surface.

7. The liquid discharge head according to claim 1, wherein the first surface of the cover member is directly joined to the discharge chip with the adhesive.

8. The liquid discharge head according to claim 1, wherein the first surface of the cover member is directly joined to the discharge chip with the adhesive and an intermediate member.

9. A method for manufacturing a liquid discharge head, the liquid discharge head including a discharge chip including a discharge port for discharging liquid, and a cover member having an opening for exposing the discharge chip, the cover member including a first surface which is joined to the discharge chip with adhesive, and a second surface which is a surface opposite from the first surface, wherein, at least in a part of the opening as viewed from a direction perpendicular to the second surface, an edge on the second surface side is positioned inside the opening with respect to an edge on the first surface side, the method comprising:
applying the adhesive to the discharge chip;
performing image processing including imaging the discharge chip and the edge on the second surface side in at least the part of the opening in the cover member using a camera disposed in the direction perpendicular to the second surface;
adjusting a position of the cover member with respect to the discharge chip based on a result of the image processing; and
joining the discharge chip and the cover member by curing the adhesive.

10. The method for manufacturing the liquid discharge head according to claim 9, wherein a side surface of the opening has an inverted taper shape in the cover member.

11. The method for manufacturing the liquid discharge head according to claim 10, wherein an angle at which the first surface and the side surface of the opening intersect with each other is greater than 95 degrees and equal to or less than 150 degrees in the cover member.

12. The method for manufacturing the liquid discharge head according to claim 9, wherein the image processing includes detecting an alignment mark included in the discharge chip.

13. The method for manufacturing the liquid discharge head according to claim 12, wherein the image processing includes detecting the alignment mark that has a shortest distance of 1 millimeter or less to the edge on the second surface side as viewed from the direction perpendicular to the second surface.

14. The method for manufacturing the liquid discharge head according to claim 12, wherein the image processing includes detecting the discharge port as the alignment mark.
